(19) United States
(12) Patent Application Publication
(10) Pub. No.: US 2025/0325132 A1
(43) Pub. Date: Oct. 23, 2025

(54) SECURE DEVICE FOR PACKAGE DELIVERY

(71) Applicant: Xueyan WANG, Huizhou (CN)

(72) Inventor: Xueyan WANG, Huizhou (CN)

(21) Appl. No.: 18/742,245

(22) Filed: Jun. 13, 2024

(30) Foreign Application Priority Data
Apr. 18, 2024 (CN) 202420797053X

(51) Int. Cl. A47G 29/20; E05B 65/52; E05B 67/00; E05B 73/00

(52) U.S. Cl. CPC A47G 29/20; E05B 67/003; E05B 73/0005; E05B 65/52

(57) ABSTRACT

Embodiments of the present disclosure provide a secure device for package delivery, including a plurality of chains, a limiting frame, and a first lock, wherein first ends of the plurality of chains each are connected to the limiting frame and are distributed apart from each other around a periphery of the limiting frame, and the first ends of the plurality of chains are limited by the limiting frame such that portions of the plurality of chains away from the limiting frame can be pulled up to be wrapped around a package; and each chain is provided with a plurality of chain holes distributed apart from each other along its own length direction, and the first lock can successively pass through a chain hole of each of the chains to lock together the plurality of chains that are pulled up, thereby binding and locking the package.

### TECHNICAL FIELD

The present disclosure relates to the field of security and anti-theft devices, in particular to a secure device for package delivery.

### BACKGROUND ART

At present, with the increasing number of express packages from online shopping, the problem of theft during package delivery has become increasingly serious. Currently, there are two main methods for solving the problems of security and anti-theft during package delivery: One method is to use a package pick up station in an apartment building. Some package pick up stations are not free, and not all apartments are provided with a package pick up station. When some recipients do not pick up their packages in time, the package pick up station may become full and be unable to accommodate new packages. The other method is to use personal delivery boxes in detached villas.

These personal delivery boxes are full-enclosure type secure devices, which store packages in the boxes, and the packages of suitable sizes can be placed and locked inside the boxes.

### SUMMARY

Embodiments of one aspect of the present disclosure provide a secure device for package delivery, in which a plurality of chains are used to bind a package. The chain has high structural strength, is not easily cut off, and is good in security. Moreover, a limiting frame is used to limit first ends of the plurality of chains, and cooperates with a first lock to limit and lock the plurality of chains, so that the package is well secured. Moreover, for packages of different sizes, the first lock can lock the plurality of chains at different positions, so that the secure device has a good universality.

Additional aspects and/or advantages of the general concept of the present disclosure will be set forth in part in the description that follows, and in part will be obvious from the description, or may be learned by practice of the general concept of the present disclosure.

### BRIEF DESCRIPTION OF THE DRAWINGS

The above and other objects and features of the present disclosure will become clearer from the following description of embodiments with reference to the drawings, in which:

FIG. 1 is a schematic structural diagram of a secure device for package delivery according to a first embodiment of the present disclosure;

FIG. 2 is a schematic diagram of a secure device for package delivery according to a second embodiment of the present disclosure with a package being bound;

FIG. 3 is a schematic structural diagram of a secure device for package delivery according to a third embodiment of the present disclosure in the process of binding a package;

FIG. 4 is a partial schematic structural diagram of a secure device for package delivery according to a fourth embodiment of the present disclosure in the process of binding a package;

FIG. 5 is a schematic structural diagram of a secure device for package delivery according to a fifth embodiment of the present disclosure;

FIG. 6 is a schematic structural diagram of a secure device for package delivery according to a sixth embodiment of the present disclosure.

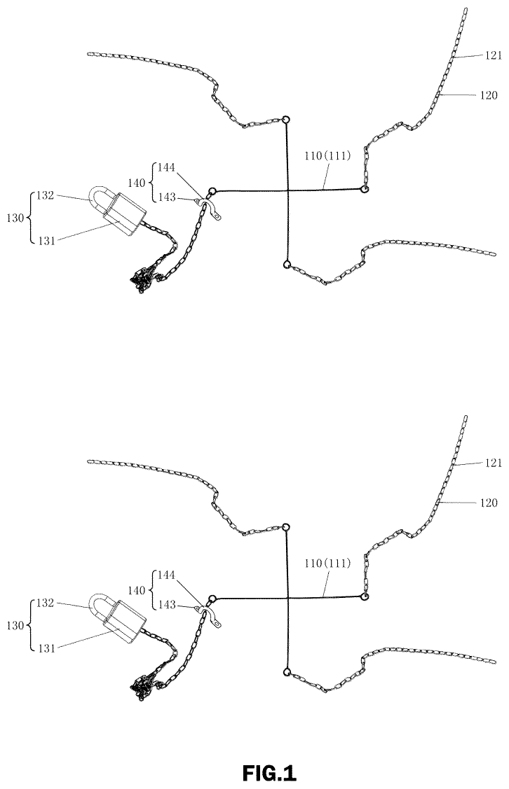

List of reference numerals in FIGS. 1 to 6:
10 package,
110 limiting frame, 111 connecting rod,
120 chain, 121 chain hole,
130 first lock, 131 lock body, 132 shackle, 133 limiting portion, 1331 limiting rod,
1332 stop portion, 1333 insertion hole, 134 locking portion, 1341 lock body, 1342 shackle,
140 fixing connector, 141 screw, 142 fixing chain, 143 connecting plate, 144 connecting hook,
150 pressing plate, 151 protruding ring, 152 recess,
160 storage box, 161 box body, 162 cover, 163 third lock,
170 second lock.

### DETAILED DESCRIPTION OF EMBODIMENTS

The technical solutions in the embodiments of the present disclosure are clearly and completely described below with reference to the accompanying drawings for the embodiments of the present disclosure. Apparently, the described embodiments are merely some rather than all of the embodiments of the present disclosure. Based on the embodiments of the present disclosure, all other embodiments obtained by those of ordinary skill in the art without creative efforts fall within the scope of protection of the present disclosure. In addition, unless there are contradictory descriptions, the various embodiments described below may also be combined with each other.

It should be noted that orientation words such as “upper”, “lower” and “bottom” limited in the present application are all based on the orientation of the product when it is placed upright during normal use as a reference direction. The limitation should not be understood as a specific limitation to the embodiments of the present application. In addition, in this context, it also needs to be explained that when one element is connected to another element, the connection may be either direct connection or indirect connection, unless it is explicitly stated that one element is directly connected to another element. The terms “first”, “second”, “third” and “fourth” are used for descriptive purposes only, and cannot be construed as indicating or implying relative importance or implicitly indicating the number of technical features indicated. In the description of the present disclosure, “a plurality of” means three or more, unless otherwise specified.

Embodiments of the present disclosure provide a secure device for package delivery, which reduces the risk of packages being stolen and improves the security of the packages.

FIG. 1 is a schematic structural diagram of a secure device for package delivery according to an embodiment of the present disclosure. Referring to FIG. 1, the secure device for package delivery (hereinafter referred to as the secure device) includes a plurality of chains 120, a limiting frame 110, and a first lock 130.

First ends of the plurality of chains 120 each are connected to the limiting frame 110 and are distributed apart from each other around a periphery of the limiting frame 110, and the first ends of the plurality of chains 120 are limited by the limiting frame 110 such that portions of the plurality of chains 120 away from the limiting frame 110 can be pulled up to be wrapped around a package 10. Each chain 120 is provided with a plurality of chain holes 121 distributed apart from each other along its own length direction, and the first lock 130 can successively pass through a chain hole 121 of each of the chains 120 to lock together the plurality of chains 120 that are pulled up, thereby binding the package 10.

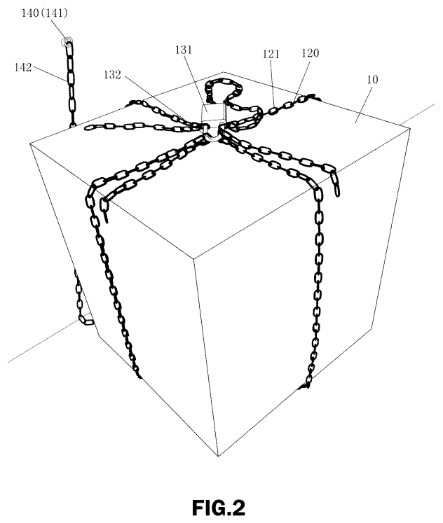

FIG. 2 is a schematic structural diagram of the secure device in this embodiment with a package 10 being bound. As shown in FIG. 2, in this embodiment, a plurality of chains 120 are used to bind the package 10. The chain 120 is sturdy and durable, and not easily cut off, and can prevent the package 10 from being stolen. Moreover, the chain 120 itself is provided with a plurality of chain holes 121. Whatever size a package 10 to be bound has, large or small, after the plurality of chains 120 are pulled up and gathered together, each chain 120 can have a chain hole 121 at an appropriate position for the first lock 130 to be inserted, so as to be locked. The secure device can bind packages 10 of various sizes and thus has a good universality. Moreover, the first ends of the plurality of chains 120 are limited by the limiting frame 110, and after main portions of the chains 120 bind the package 10, the plurality of chains 120 are locked together by the first lock 130. The plurality of chains 120 are limited by both of the limiting frame 110 and the first lock 130, and after the package 10 is bound by the plurality of chains 120, the chains 120 will not shift by a significant distance even if the chains 120 are pulled, so that the package 10 can be prevented from being taken out from a gap between two adjacent chains 120, and the package 10 is well secured.

In addition, compared with personal delivery boxes used in the related art to store packages 10, the secure device of this embodiment eliminates the need of fully enclosing the package 10, so that less raw materials are used, the cost is lower, less space is occupied, and the transportation is facilitated. Moreover, if the chains 120 are long enough, large-sized packages 10 can also be easily bound.

Further, the plurality of chains 120 may be metal chains. For example, the chain 120 is a stainless steel chain, which is sturdy and not likely to rust.

Further, at least four chains 120 may be provided and are configured to be wrapped around all sides of the package 10, respectively. Thus, it is favorable to firmly bind the package 10. The plurality of chains 120 are distributed circumferentially around the limiting frame 110. For example, the plurality of chains 120 are distributed around the center of the limiting frame 110 at equal included angles or centrosymmetrically.

Further, the limiting frame 110 is not prone to deformation or has little deformation. The first ends of the chains 120 connected to the limiting frame 110 will not be displaced significantly. After the chains 120 are wrapped around the package 10, the limiting frame 110 can limit the shift range of the chains 120, thus preventing the chains 120 from being pulled apart or displaced by a thief to take away the package 10.

As an example, the limiting frame 110 is made of metal, such as stainless steel.

As an example, the limiting frame 110 is made of a rigid plastic.

In a specific application, the limiting frame 110 may be placed on the ground, and delivery personnel should try to align the center of the bottom of the package 10 with a center point of the limiting frame 110, and then operate the chain 120 and the first lock 130 to complete the binding and locking of the package 10.

The size of the limiting frame 110 may be determined depending on the size of the package 10. If the limiting frame 110 is too small relative to the package 10, a movable space for the chains 120 wrapped around the package 10 becomes large, so that the chains 120 tend to shift greatly, resulting in that the package 10 is taken out from the gap between the chains 120. If the size of the limiting frame 110 is too large relative to the package 10, for example, the edge of the limiting frame 110 extends outward relative to the package 10, the first ends of the chains 120 are liable to be separated from the package 10, thus the chains 120 cannot be tightly attached to the package 10, which increases the gap between the chains 120 and also increases the probability of the package 10 being taken out from the gap between the chains 120. Therefore, the size design of the limiting frame 110 may refer to the size range of the package 10 to which the limiting frame 110 is adapted. For example, manufacturers can design secure devices with limiting frames 110 of different sizes, so that the secure device can be suitable for packages 10 with different size ranges, and it is convenient for users to purchase corresponding secure devices according to their needs.

For example, the size of the limiting frame 110 is designed to be suitable for medium- and large-sized packages 10. Taking a package 10 with a cross-sectional area greater than 0.09 cm² and less than 0.5 m² as an example, under the condition that a region occupied by the limiting frame 110 is square, the area of the region occupied by the limiting frame 110 is 0.09 m². After the chains 120 bind the package 10, the chains 120 are limited by the limiting frame 110, the package 10 and the first lock 130, and cannot move by a large distance, thus reducing the probability that the package 10 is taken out from the gap between the chains 120.

Of course, the size of the limiting frame 110 may also be changed to improve the application scope of the package 10. For example, the limiting frame 110 is enabled to be foldable. If a large-sized package 10 is to be bound, the limiting frame 110 is unfolded, and the chains 120 are limited by a large-sized frame. If a small-sized package 10 is to be bound, the limiting frame 110 is folded, and the chains 120 are limited by a small-sized frame, thus improving the universality of the secure device. For another example, the limiting frame 110 is enabled to be retractable. If a large-sized package 10 is to be bound, the limiting frame 110 is extended, and the chains 120 are limited by a large-sized frame. If a small-sized package 10 is to be bound, the limiting frame 110 is retracted, and the chains 120 are limited by a small-sized frame.

As an example, as shown in FIG. 1 and FIG. 2, the limiting frame 110 includes four connecting rods 111 which are cross-connected in a cruciform shape, so that the structure is simple, the materials are saved on, and the cost is reduced.

In this case, the secure device may include four chains 120, which are respectively connected to four end portions of the connecting rod 111, and can bind the package 10 upward from four sides of the package 10.

Of course, the structure of the limiting frame 110 is not limited to the above example. The limiting frame 110 may also be square, circular, oval or polygonal. For example, the limiting frame 110 is a square plate, a circular plate and a polygonal structure with hollow holes; for another example, the limiting frame 110 is formed by crossing two ovals, and the like, as long as the structure of the limiting frame 110 can meet the function of limiting the chains 120, which will not be enumerated herein.

The connection mode of the chains 120 and the limiting frame 110 may be that, for example, each chain 120 is in welded connection to the limiting frame 110 at one end. The connection is firm, and the limiting frame 110 can effectively limit the ends of the chains 120, so as to prevent the chains 120 from being pulled apart to cause the package 10 to be lost. For another example, each chain 120 is rotatably connected to the limiting frame 110 at one end. It is convenient to rotate the chains 120 to enable same to be fully attached to the package 10 on the limiting frame 110. Moreover, although the chains 120 are rotatably connected to the limiting frame 110, the chains 120 will not shift circumferentially along the limiting frame 110, and the chains 120 can also be prevented from being pulled apart to cause the package 10 to be lost.

For the specific structure of the first lock 130, further, in some embodiments, as shown in FIGS. 1, 2 and 5, the first lock 130 includes a lock body 131 and a shackle 132 arranged on the lock body 131. The shackle 132 can be opened relative to the lock body 131 so as to successively pass through the chain hole 121 of each of the chains 120; and the shackle 132 can also be inserted into the lock body 131 so as to lock the plurality of chains 120 together. The structure is simple, and the operation is convenient. Moreover, since a key is not needed in the process of inserting the shackle 132 into the lock body 131, the delivery personnel can use the secure device to bind the package 10 even without the key, and a recipient only needs to keep the key himself/herself, so the applicability of the secure device is wide.

As an example, referring to FIGS. 1 and 2, the first lock 130 may be a padlock. The shackle 132 is rotatably connected to the lock body 131 at one end, the shackle 132 can be opened and rotate relative to the lock body 131, successively pass through the chain hole 121 of each of the chains 120, and then rotate toward the lock body 131 again and be inserted into the lock body 131 so as to lock the plurality of chains 120 together.

In a specific application, the recipient places the first lock 130 in an opened state before leaving. When the delivery personnel deliver and bind the package 10, first, the first chain 120 may be wrapped around the package 10 and pulled to the middle of an upper part of the package 10, and the shackle 132 may be inserted into one chain hole 121 located in the center of the upper part of the package 10, then the second chain 120 can be pulled to the middle of the upper part of the package 10, and the shackle 132 is inserted into one chain hole 121 of the second chain 120 that is located in the center of the upper part of the package 10, then the third chain 120, the fourth chain 120 and so on are pulled up in turn, and the shackle 132 is successively inserted into a corresponding chain hole 121 of each chain 120. After it is determined that the chains 120 are kept in a tensioned state and are not loose, the shackle 132 is inserted into the lock body 131 to complete the binding and locking of the package 10.

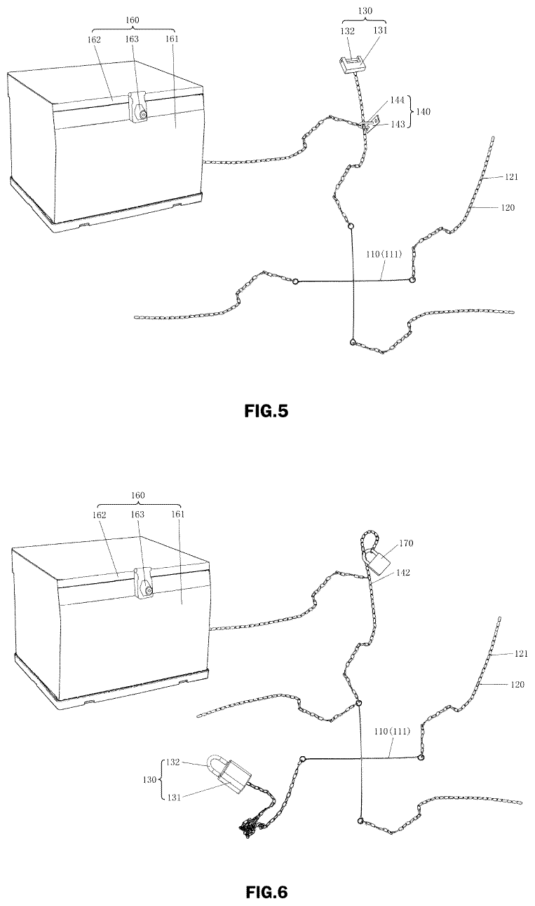

As an example, referring to FIG. 5, the first lock 130 may also be a lateral opening padlock. The lock body 131 is provided with two lugs distributed apart from each other, two ends of the shackle 132 are connected to the two lugs respectively, the shackle 132 is formed as a pin rod and can move transversely along the lock body 131, one end of the shackle 132 is movably connected to one lug, and the other end of the shackle 132 may be withdrawn from the other lug to complete unlocking, and after the chains 120 are limited, the other end of the shackle 132 may be inserted into the other lug to complete locking.

Here, the first lock 130 may be fixedly or movably connected to one of the plurality of chains 120 to prevent the first lock 130 from getting lost. Of course, the first lock 130 may also be placed independently.

In addition, the first lock 130 may be opened with a key or a password.

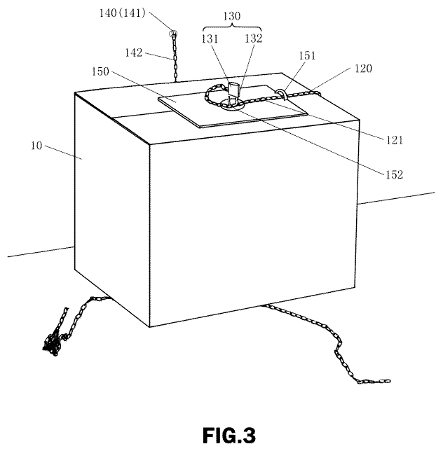

In order to facilitate the locking of the first lock 130, further, as shown in FIG. 3, the secure device may further include a pressing plate 150 for pressing against the upper part of the package 10 and allowing the first lock 130 to lock the plurality of chains 120 above the pressing plate 150.

According to some embodiments, in addition to binding packages 10 in the form of boxes, the secure device may also be used to bind flexible packages 10 or packages 10 of special-shaped structures. When a flexible package 10 or a package 10 of a special-shaped structure is bound, it is inconvenient to operate the first lock 130. Therefore, it is more convenient to operate the first lock 130 by pressing down the package 10 with the pressing plate 150.

The pressing plate 150 may be movably connected to one of the plurality of chains 120 to move along the chain 120. It is convenient to adjust the position of the pressing plate 150 according to the size of the package 10.

As an example, as shown in FIG. 3, a raised protruding ring 151 is provided on a first surface of the pressing plate 150, and one of the plurality of chains 120 can pass through the protruding ring 151, such that the pressing plate 150 can move along the chain 120, so as to adjustably connect the pressing plate 150 to the chain 120.

In order to avoid the loss of the pressing plate 150 due to being separated from the chain 120, it is also possible to connect the first lock 130 and the pressing plate 150 to the same chain 120, and use the first lock 130 to prevent the protruding ring 151 from being separated from the chain 120, thereby preventing the pressing plate 150 from being separated from the chain 120.

In addition, as shown in FIG. 3, a recess 152 may be provided in the middle of the pressing plate 150 to limit the first lock 130 in such a way that the first lock 130 moves in the recess 152 during locking the plurality of chains 120 together. The first lock 130 can be prevented from sliding greatly in the locking process, so that the first lock 130 is convenient to operate.

As an example, as shown in FIG. 3, the recess 152 is a circular pit, and when the package 10 needs to be bound, the shackle 132 of the first lock 130 can abut against the interior of the recess 152 for a locking operation. The recess 152 can assist the shackle 132 in aligning with the corresponding chain hole 121 for insertion.

In addition, the pressing plate 150 can also add other protective functions of the secure device. For example: the pressing plate 150 can prevent the package 10 from getting wet in the rain.

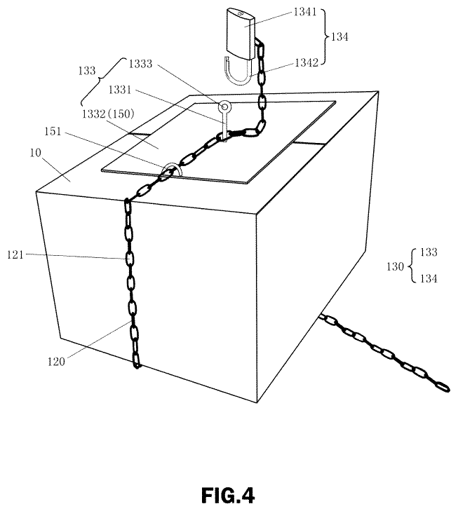

In some other embodiments, as shown in FIG. 4, the first lock 130 includes a limiting portion 133 and a locking portion 134, wherein the limiting portion 133 can successively pass through the chain hole 121 of each of the plurality of chains 120 in order to limit the plurality of chains 120 together, and the locking portion 134 is configured to lock the plurality of chains 120 on the limiting portion 133.

In these embodiments, the first lock 130 is designed as two parts that can be separated from each other, one part is the limiting portion 133, which passes through the chain holes 121 of the plurality of chains 120, and the other part is the locking portion 134, which locks the plurality of chains 120 to the limiting portion 133. Compared with a lock where a lock body 131 and a shackle 132 are inseparable, the first lock 130 has the advantages that it is convenient to take the limiting portion 133 and enable the limiting portion 133 to successively pass through the chain hole 121 of each of the plurality of chains 120, and the operation is convenient.

As an example, as shown in FIG. 4, the limiting portion 133 includes a limiting rod 1331, a stop portion 1332 located at a first end of the limiting rod 1331 and an insertion hole 1333 located at a second end of the limiting rod 1331, wherein the second end of the limiting rod 1331 can pass through the chain hole 121, and the stop portion 1332 is configured to prevent the chain 120 from being separated from the limiting rod 1331 at the first end of the limiting rod 1331. The locking portion 134 includes a lock body 1341 and a shackle 1342 arranged on the lock body 1341, wherein the shackle 1342 can be opened relative to the lock body 1341, pass through the insertion hole 1333 and then be inserted into the lock body 1341, and the locking portion 134 is configured to prevent the chain 120 from being separated from the limiting rod 1331 at the second end of the limiting rod 1331.

Here, the insertion hole 1333 may be directly formed in the limiting rod 1331, or the second end of the limiting rod 1331 may be provided with a connecting ring, and the insertion hole 1333 is formed inside the connecting ring.

In order to prevent the first lock 130 from getting lost, the limiting portion 133 may be connected to one of the plurality of chains 120, and the locking portion 134 may be connected to one of the plurality of chains 120. The limiting portion 133 and the locking portion 134 may be connected to the same chain 120 or to different chains 120 respectively.

For example, as shown in FIG. 4, the limiting portion 133 and the locking portion 134 are connected to the same chain 120, and the locking portion 134 is used to prevent the limiting portion 133 from being separated from the chain 120.

For another example, as shown in FIG. 4, the secure device further includes a pressing plate 150 for pressing against the upper part of the package 10, and the pressing plate 150 is configured as the stop portion 1332. A raised protruding ring 151 is further provided on the first surface of the pressing plate 150, and one of the plurality of chains 120 can pass through the protruding ring 151, such that the pressing plate 150 can move along the chain 120, so as to adjustably connect the pressing plate 150 to the chain 120. The pressing plate 150 is designed to not only press down the package 10 to facilitate tightening the package 10 with the chains 120 and limiting the package 10, but also provide support for the limiting rod 1331 to enable the limiting rod 1331 to be stably erected on the package 10 so as to conveniently pass through the chain hole 121 of each of the plurality of chains 120 successively.

Here, the limiting rod 1331 may also be rotatably connected to the pressing plate 150. For example, a lower end of the limiting rod 1331 may be rotatably inserted into the pressing plate 150, making it convenient to rotate the position of the limiting portion 133 to enable the limiting portion 133 to pass through the chain hole 121, and the operation is convenient.

For another example, the secure device further includes a pressing plate 150 for pressing against the upper part of the package 10, and the limiting portion 133 is fixedly or rotatably connected to the first surface of the pressing plate 150. A raised protruding ring 151 is further provided on the first surface of the pressing plate 150, and one of the plurality of chains 120 can pass through the protruding ring 151, such that the pressing plate 150 can move along the chain 120, so as to adjustably connect the pressing plate 150 to the chain 120. Here, the stop portion 1332 and the pressing plate 150 are not the same part, and are formed independently. The pressing plate 150 can provide support for the limiting portion 133, so that the limiting portion 133 can conveniently pass through the chain hole 121. Similarly, under the condition that the limiting portion 133 is rotatably connected to the pressing plate 150, the position of the limiting portion 133 can be conveniently rotated to enable the limiting portion 133 to pass through the chain hole 121, and the operation is convenient.

The locking portion 134 and the pressing plate 150 are connected to the same chain 120, and the locking portion 134 can prevent the protruding ring 151 from being separated from the chain 120. The pressing plate 150 can be effectively prevented from being separated from the chain 120, thereby preventing the limiting portion 133 from being separated from the chain 120.

The specific structure of the locking portion 134 may be similar to that of the first lock 130, the structure is simple, and the operation is convenient.

In order to improve the security, further, in some embodiments, as shown in FIGS. 1, 2, 3 and 5, the secure device may further include a fixing connector 140 for being connected to an external fixed structure. The fixing connector 140 may be connected to the limiting frame 110 or any one of the plurality of chains 120.

The fixing connector 140 may be directly connected to the limiting frame 110, such that the limiting frame 110, may be fixed to the ground. In addition, the fixing connector 140 may be connected to the limiting frame 110 by means of a flexible connector. The flexible connector may be a steel wire rope, a chain, etc.

In these embodiments, the secure device is connected to the external fixed structure by means of the fixing connector 140, thereby preventing the secure device from being stolen and enhancing the security of the secure device.

As an example, as shown in FIGS. 2 and 3, the fixing connector 140 includes a screw 141 and a fixing chain 142.

In this case, referring to FIGS. 2 and 3, the fixed structure may be a wall of a house, and the screw 141 is inserted into the wall, so that the secure device is not easily lost. Of course, the fixed structure may also be a doorpost, and the screw 141 is inserted into the doorpost.

The fixing connector 140 is not limited to a screw 141, and may also be other components that can connect the secure device to the fixed structure. For example, the fixing connector 140 may also be a connecting hook 144, the connecting hook 144 may be U-shaped, circular or oval, and the fixing connector 140 is provided with a mounting hole, and may be connected to the fixed structure by enabling a connecting screw to pass through the mounting hole.

As an example, as shown in FIGS. 1 and 5, the fixing connector 140 includes a U-shaped connecting hook 144, the U-shaped connecting hook 144 is provided with a connecting plate 143, any one of the plurality of chains 120 can pass through the connecting hook 144, and the connecting plate 143 is provided with through holes, and may be connected to the fixed structure by enabling connecting screws to pass through the through holes, thereby fixedly connecting the fixing connector 140 to the fixed structure.

Of course, the secure device may not be provided with the fixing connector 140, but is connected to the external fixed structure by other structures. In this case, the fixed structure may be a door handle or a column, etc.

As an example, as shown in FIG. 6, the secure device may further include a fixing chain 142 and a second lock 170, wherein one end of the fixing chain 142 is connected to the limiting frame 110, and the other end of the fixing chain 142 is configured to surround the fixed structure.

In a specific application, the recipient enables one end of the fixing chain 142 to pass through the fixed structure, and then enables the second lock 170 to successively pass through one chain hole 121 before the surrounding and one chain hole 121 after the surrounding and lock the fixing chain 142, thereby locking the secure device to the fixed structure.

The specific structure of the second lock 170 may be similar to that of the first lock 130, the structure is simple, and the operation is convenient.

As an example, the secure device may also use one of the plurality of chains 120 to surround the fixed structure.

In this case, one of the plurality of chains 120 may have a length greater than the length of the other chains 120, such that the second end of the longest chain 120 can be locked by the first lock 130 or the second lock 170 after surrounding the external fixed structure, so as to connect the secure device to the fixed structure.

Further, in some embodiments, as shown in FIGS. 5 and 6, the secure device may further include a storage box 160 provided with a box body 161 and a cover 162 covering the box body 161. The storage box 160 is connected to the limiting frame 110 or any one of the plurality of chains 120, and can store the package 10.

In a specific embodiment, the storage box 160 is used to store small-sized packages 10, and the plurality of chains 120 are used to bind medium- and large-sized packages 10. The delivery personnel can choose the locking structure according to the size of the package 10 when delivering the package 10, so that the whole secure device can be applied to packages 10 of various sizes, and the universality of the secure device is enhanced.

As shown in FIGS. 5 and 6, the storage box 160 may be provided with a third lock 163, which can lock the box body 161 and the cover 162, making the operation more convenient for the delivery personnel and also facilitating the simultaneous storage of a plurality of packages 10.

As an example, referring to FIGS. 5 and 6, the storage box 160 is connected to the fixing connector 140 by means of an additional chain 120, which can prevent the storage box 160 from getting lost. In addition, the plurality of chains 120 and the limiting frame 110 may be stored in the storage box 160 when not in use, thus occupying less space.

In another specific embodiment, the storage box 160 cooperates with the chains 120 for use, and the plurality of chains 120 can also bind the storage box 160. During practical use, first, the storage box 160 is used to store a package 10, and then the first lock 130 and the plurality of chains 120 are used to bind and lock the package 10. The limiting frame 110 does not extend beyond an outer edge of a bottom wall of the storage box 160, so that the chains 120 can bind the storage box 160 in a tightly attached manner.

Although the embodiments of the present disclosure have been described in detail above, those skilled in the art can make various modifications and variations to the embodiments of the present disclosure without departing from the spirit and scope of the present disclosure. It should be understood that, in the view of those skilled in the art, these modifications and variations will still fall within the spirit and scope of the embodiments of the present disclosure as defined by the claims.

1. A secure device for package delivery, the secure device comprising a plurality of chains, a limiting frame, and a first lock, wherein
first ends of the plurality of chains each are connected to the limiting frame and are distributed apart from each other around a periphery of the limiting frame, and the first ends of the plurality of chains are limited by the limiting frame such that portions of the plurality of chains away from the limiting frame are capable of being pulled up to be wrapped around a package; and
each chain is provided with a plurality of chain holes distributed apart from each other along its own length direction, and the first lock is capable of passing through a chain hole of each of the chains to lock together the plurality of chains that are pulled up, thereby binding the package.

2. The secure device for package delivery according to claim 1, wherein the secure device further comprises a fixing connector for being connected to an external fixed structure, wherein the fixing connector is connected to the limiting frame or any one of the plurality of chains.

3. The secure device for package delivery according to claim 2, wherein the fixing connector is connected to the limiting frame by means of a flexible connector.

4. The secure device for package delivery according to claim 2, wherein the fixing connector comprises a screw; or
the fixing connector comprises a connecting hook, wherein the fixing connector is provided with a mounting hole and is capable of being connected to the fixed structure by means of a connecting screw.

5. The secure device for package delivery according to claim 1, wherein the secure device further comprises a fixing chain and a second lock, wherein one end of the fixing chain is connected to the limiting frame, the other end of the fixing chain is capable of surrounding an external fixed structure, and the second lock is capable of passing through chain holes of the fixing chain before the surrounding and after the surrounding so as to lock the fixing chain to the fixed structure.

6. The secure device for package delivery according to claim 1, wherein one of the plurality of chains has a length greater than the length of the other chains, such that a second end of the chain is capable of being locked by the first lock after surrounding the external fixed structure, so as to connect the secure device to the fixed structure.

7. The secure device for package delivery according to claim 1, wherein the first lock comprises a lock body and a shackle arranged on the lock body, wherein the shackle is capable of being opened relative to the lock body so as to successively pass through the chain hole of each of the chains, and the shackle is also capable of being inserted into the lock body so as to lock the plurality of chains together.

8. The secure device for package delivery according to claim 1, wherein the first lock is fixedly or movably connected to one of the plurality of chains.

9. The secure device for package delivery according to claim 1, wherein the secure device further comprises a pressing plate, wherein the pressing plate is configured to press against an upper part of the package and allows the first lock to lock the plurality of chains above the pressing plate, and a raised protruding ring is provided on a first surface of the pressing plate, and one of the plurality of chains is capable of passing through the protruding ring such that the pressing plate is capable of moving along the chain, so as to adjustably connect the pressing plate to the chain.

10. The secure device for package delivery according to claim 9, wherein the first lock and the pressing plate are connected to the same chain, and the first lock is capable of preventing the protruding ring from being separated from the chain; and/or
a recess is further provided in the middle of the pressing plate and is configured to limit the first lock in such a way that the first lock moves in the recess during locking the plurality of chains together.

11. The secure device for package delivery according to claim 1, wherein the first lock comprises a limiting portion and a locking portion, wherein the limiting portion is capable of successively passing through a chain hole of each of the plurality of chains to limit the plurality of chains together, and the locking portion is configured to lock the plurality of chains to the limiting portion.

12. The secure device for package delivery according to claim 11, wherein the limiting portion is connected to one of the plurality of chains, and the locking portion is connected to one of the plurality of chains.

13. The secure device for package delivery according to claim 11, wherein the limiting portion comprises a limiting rod, a stop portion located at a first end of the limiting rod, and an insertion hole located at a second end of the limiting rod, wherein the second end of the limiting rod is capable of passing through the chain hole, and the stop portion is configured to prevent the chain from being separated from the limiting rod at the first end of the limiting rod; and
the locking portion comprises a lock body and a shackle arranged on the lock body, wherein the shackle is capable of being opened relative to the lock body, passing through the insertion hole and being inserted into the lock body, and the locking portion is configured to prevent the chain from being separated from the limiting rod at the second end of the limiting rod.

14. The secure device for package delivery according to claim 13, wherein the secure device further comprises a pressing plate, wherein the pressing plate is configured to press against an upper part of the package, the pressing plate is configured as the stop portion, or the limiting portion is fixedly connected or rotatably connected to a first surface of the pressing plate; and
a raised protruding ring is further provided on the first surface of the pressing plate, and one of the plurality of chains is capable of passing through the protruding ring such that the pressing plate is capable of moving along the chain, so as to adjustably connect the pressing plate to the chain.

15. The secure device for package delivery according to claim 14, wherein the locking portion and the pressing plate are connected to the same chain, and the locking portion is capable of preventing the protruding ring from being separated from the chain.

16. The secure device for package delivery according to claim 1, wherein at least four chains are provided, and the plurality of chains are distributed circumferentially around the limiting frame and are configured to be wrapped around all sides of the package respectively.

17. The secure device for package delivery according to claim 1, wherein the limiting frame is cross-shaped, square, circular, oval or polygonal; and/or
each of the chains is fixedly or rotatably connected to the limiting frame at one end.

18. The secure device for package delivery according to claim 1, wherein the secure device further comprises
a storage box having a box body and a cover covering the box body, the storage box being connected to the limiting frame or any one of the plurality of chains and capable of storing the package.

19. The secure device for package delivery according to claim 18, wherein the limiting frame does not extend beyond an outer edge of a bottom wall of the storage box, and the plurality of chains are also capable of binding the storage box.

20. The secure device for package delivery according to claim 18, wherein the storage box is also provided with a third lock capable of locking the box body and the cover.
